(19) United States
(12) Patent Application Publication
(10) Pub. No.: US 2017/0310360 A1
(43) Pub. Date: Oct. 26, 2017

(54) ECHO REMOVAL DEVICE, ECHO REMOVAL METHOD, AND NON-TRANSITORY STORAGE MEDIUM

(71) Applicant: JVC KENWOOD Corporation, Yokohama-shi (JP)

(72) Inventors: Takahiro Gejo, Yokohama-shi (JP); Hisako Murata, Yokohama-shi (JP); Masaya Konishi, Yokohama-shi (JP); Yumi Fujii, Yokohama-shi (JP); Keisuke Oda, Yokohama-shi (JP)

(21) Appl. No.: 15/489,799

(22) Filed: Apr. 18, 2017

(30) Foreign Application Priority Data
Apr. 25, 2016 (JP) 2016-086760

(51) Int. Cl. H04B 3/23; H04M 3/00; H04B 7/015

(52) U.S. Cl. CPC H04B 3/237; H04B 7/015; H04M 3/002

(57) ABSTRACT

An echo removal device comprises: an echo canceller that includes a first delay unit configured to delay a reception signal from a communication counterpart, and that is configured to subtract, from a transmission signal for the communication counterpart, a cancellation signal that is generated based on the delayed reception signal obtained by the first delay unit and property information which simulates a property of an echo path; a second delay unit configured to delay the reception signal by an amount of delay different from an amount of delay of the first delay unit; an echo suppressor configured to receive the delayed reception signal obtained by the second delay unit and an output of the echo canceller; and a delay amount calculator configured to calculate and set the amount of delay of the first delay unit and the amount of delay of the second delay unit based on the property information.

### CROSS-REFERENCE TO RELATED APPLICATION

The present application claims priority to and incorporates by reference the entire contents of Japanese Patent Application No. 2016-086760 filed in Japan on Apr. 25, 2016.

### FIELD

The present application relates to an echo removal device, an echo removal method, and a non-transitory storage medium.

### BACKGROUND

An echo canceller and an echo suppressor are sometimes used to remove acoustic echo occurring in hands-free calling in a vehicle, a video conference system and the like. A device that uses the echo canceller and the echo suppressor in combination is disclosed in Japanese Laid-open Patent Publication No. 2010-273316 A. The device in the document realizes echo removal by attenuating echo by the echo canceller by estimating an echo path using an adaptive filter, and by further attenuating, by the echo suppressor or the like, residual echo not erased by the echo canceller.

Many problems still remain for reduction in the amount of echo attenuation due to background noise on a transmission side, and echo removal performance on double-talk state when a talker and a listener speak at the same time, and there is room for improvement.

### SUMMARY

It is an object of the present application to at least partially solve the problems in the conventional technology.

According to one aspect, there is provided a echo removal device comprising: an echo canceller that includes a first delay unit configured to delay a reception signal from a communication counterpart, and that is configured to subtract, from a transmission signal for the communication counterpart, a cancellation signal that is generated based on the delayed reception signal obtained by the first delay unit and property information which simulates a property of an echo path; a second delay unit configured to delay the reception signal by an amount of delay different from an amount of delay of the first delay unit; an echo suppressor configured to receive the delayed reception signal obtained by the second delay unit and an output of the echo canceller; and a delay amount calculator configured to calculate and set the amount of delay of the first delay unit and the amount of delay of the second delay unit based on the property information.

According to one aspect, there is provided a echo removal method comprising: delaying a reception signal from a communication counterpart by a first delay unit; generating a cancellation signal that is generated based on the delayed reception signal obtained by the first delay unit and property information which simulates a property of an echo path; subtracting the cancellation signal from a transmission signal for the communication counterpart; delaying the reception signal by a second delay unit by an amount of delay different from an amount of delay of the first delay unit; calculating and setting the amount of delay of the first delay unit and the amount of delay of the second delay unit based on the property information; and attenuating the transmission signal based on the delayed reception signal obtained by the second delay unit and the transmission signal subtracted by the cancellation signal.

According to one aspect, there is provided a non-transitory storage medium that stores an echo removal program for causing a computer to function as: an echo canceller that includes a first delay unit configured to delay a reception signal from a communication counterpart, and that is configured to subtract, from a transmission signal for the communication counterpart, a cancellation signal that is generated based on the delayed reception signal obtained by the first delay unit and property information which simulates a property of an echo path; a second delay unit configured to delay the reception signal by an amount of delay different from an amount of delay of the first delay unit; an echo suppressor configured to receive the delayed reception signal obtained by the second delay unit and an output of the echo canceller; and a delay amount calculator configured to calculate and set the amount of delay of the first delay unit and the amount of delay of the second delay unit based on the property information.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a diagram illustrating an example configuration of an echo removal device according to a present embodiment;

FIG. 2 is a diagram illustrating an example configuration of a general echo removal device;

FIG. 3 is a flowchart illustrating an example of echo cancellation operation of an echo canceller;

FIG. 4 is a flowchart illustrating an example of operation of an echo suppressor in FIG. 1;

FIG. 5 is a flowchart illustrating an example of operation of a double-talk detector in FIG. 1; and

FIG. 6 is a flowchart illustrating an example of operation of a delay amount calculator in FIG. 1.

### DETAILED DESCRIPTION OF THE PREFERRED EMBODIMENTS

Embodiments of the present application will be described in detail below with reference to the drawings. In the description of the embodiment below, the same or equivalent elements are denoted by the same reference signs, and descriptions thereof are simplified or omitted. Additionally, the present application is not limited to the embodiments. Furthermore, the structural elements of the embodiments include structural elements that can be easily replaced by those skilled in the art, or that are substantially the same as the structural elements of the embodiments. Furthermore, a plurality of modifications described in the embodiments can be arbitrarily combined within the scope obvious to those skilled in the art.

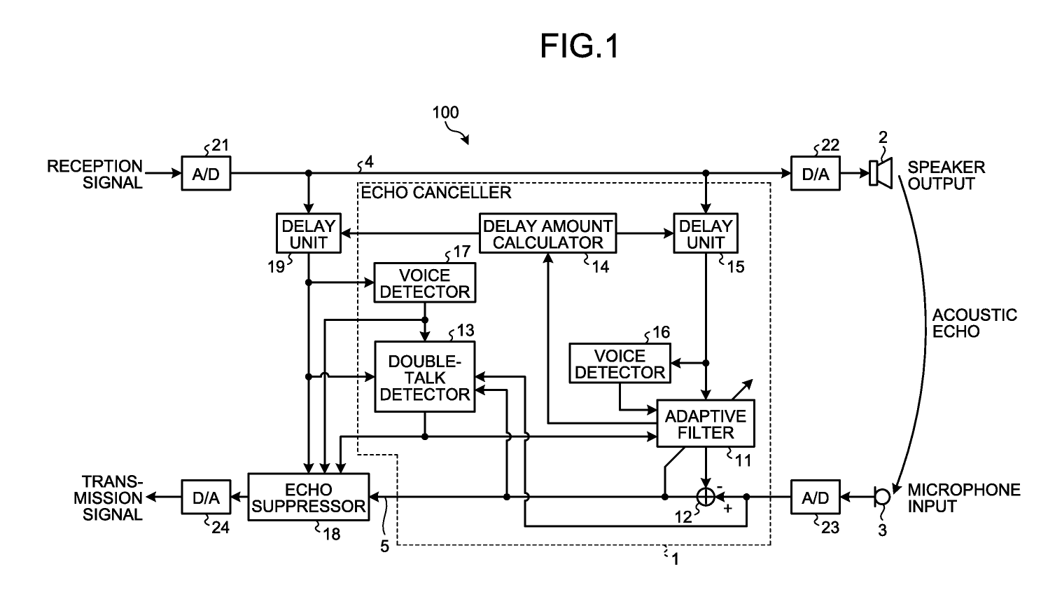

An example configuration of an echo removal device will be described. FIG. 1 is a diagram illustrating an example configuration of an echo removal device according to the present embodiment. As illustrated in FIG. 1, an echo removal device 100 according to the present embodiment includes an echo canceller 1, an echo suppressor 18, and a delay unit 19. The echo canceller 1, the echo suppressor 18, and the delay unit 19 may be realized by using a digital signal processor (DSP), for example.

The echo removal device 100 includes, on a signal path 4 for a listener-side, an A/D converter 21, a D/A converter 22, and a speaker 2. Furthermore, the echo removal device 100 includes, on a signal path 5 for a talker-side, a microphone 3, an A/D converter 23, and a D/A converter 24. The speaker 2 converts a reception signal into sound, and outputs the sound. The microphone 3 converts input sound into an electrical signal, and outputs the electrical signal. The A/D converters 21 and 23 convert an analog signal into a digital signal. The D/A converters 22 and 24 convert a digital signal into an analog signal. The echo removal device 100 removes acoustic echo caused by inputting output of the speaker 2 to the microphone 3.

An example of the echo canceller will be described. The echo canceller 1 generates a cancellation signal, and subtracts the cancellation signal from a transmission signal for a communication counterpart. The echo canceller 1 includes an adaptive filter 11, a subtraction unit 12, a double-talk detector 13, a delay amount calculator 14, a delay unit 15, and voice detectors 16 and 17. The delay unit 15 receives input of a reception signal from the communication counterpart, and delays and outputs the reception signal. The amount of delay given by the delay amount calculator 14 is set in the delay unit 15, and the delay unit 15 delays the reception signal.

The adaptive filter 11 generates a cancellation signal by multiplying the reception signal delayed by the delay unit 15 by property information which simulates property of a space, that is, an echo path, from the output of the speaker 2 to the input of the microphone 3, and inputs the generated signal to the subtraction unit 12. The subtraction unit 12 subtracts the cancellation signal from an input signal for the microphone 3. The output of the subtraction unit 12 is input to the adaptive filter 11 as an error signal. The adaptive filter 11 updates a filter coefficient, and performs convergence the error signal to be minimized.

The delay amount calculator 14 calculates and sets mutually different amounts of delay for the delay unit 15 as a first delay unit and the delay unit 19 as a second delay unit. The delay amount calculator 14 calculates update amount of the filter coefficient of the adaptive filter 11, and sets an appropriate amount of delay in the delay unit 15. In addition, the delay amount calculator 14 calculates the amount of delay for the reception signal to be supplied to the echo suppressor 18, and sets the amount of delay in the delay unit 19. The delay amount calculator 14 calculates the amount of delay from the property information of the adaptive filter 11, that is, a shape of the filter coefficient. The delay amount calculator 14 determines whether the adaptive filter 11 is converged, and calculates, when the adaptive filter 11 is converged, a delay time (including a time before rise of an impulse response) by which the adaptive filter 11 can remove the echo most effectively, based on the coefficient of the adaptive filter 11. Furthermore, the delay amount calculator 14 calculates the delay time of echo included in a reception signal and a transmission signal. At this time, a maximum value or a first peak value instead of the maximum value when a difference between the maximum value and the minimum value is within a specific range, of the impulse response, is set to a sampling position, for example.

The delay amount calculator 14 sets the calculated delay time, that is, the calculated amount of delay, in the delay unit 15 and the delay unit 19 respectively. The amount of delay which corresponds to a delay time for system processing in the present device is set in the delay unit 15. Additionally, when the echo path is extremely long, for example, the amount of delay may include delay due to the echo path. Moreover, the amount of delay which corresponds to a time obtained by adding a delay time for an echo path between the speaker 2 and the microphone 3 to the delay time for the system processing by the present device is set in the delay unit 19. Accordingly, the mutually different amounts of delay are set in the delay unit 15 and the delay unit 19. The reception signal from the communication counterpart is input to the adaptive filter 11 through the delay unit 15. Furthermore, the reception signal is input to the echo suppressor 18 through the delay unit 19. Thereby the amount of echo attenuation and echo removal quality of the adaptive filter 11 and the echo suppressor 18 can be improved. Accordingly, the amount of echo attenuation by the echo canceller 1 can be maximized, and the residual echo not erased by the echo canceller 1 may be effectively estimated by the echo suppressor 18 and be removed.

The double-talk detector 13 detects a double-talk state in which a talker and a listener speaks at the same time. In the double-talk state, the coefficient of the adaptive filter 11 is disturbed. Accordingly, when the double-talk state is detected by the double-talk detector 13, the updating of the coefficient of the adaptive filter 11 is suspended to suppress the disturbance to a low level.

A digital signal obtained by delaying, by the delay unit 19, a digital signal which is a reception signal converted by the A/D converter 21, and a digital signal which is an input signal for the microphone 3 and converted by the A/D converter 23 are input to the double-talk detector 13. Additionally, a signal which has been subjected to echo cancellation process by the adaptive filter 11 may be input to the double-talk detector 13. For example, the double-talk detector 13 detects the double-talk state by comparing the levels of the input signals. A signal indicating result of the detection of the double-talk state by the double-talk detector 13 is input to the adaptive filter 11 and the echo suppressor 18. Example operation of the double-talk detector 13 will be described below.

The voice detector 16 and the voice detector 17 detect a voice of a communication counterpart. For example, the voice detector 16 and the voice detector 17 determine, for an input reception signal, whether a voice signal is included in each processing frame, which is a unit of processing. The voice detector 16 determines whether the voice signal is included in the reception signal delayed by the delay unit 15. When the voice detector 16 determines that the voice signal is included in the reception signal, the adaptive filter 11 performs adaptive operation. The voice detector 17 determines whether the voice signal is included in the reception signal delayed by the delay unit 19. When the voice detector 17 determines that the voice signal is included in the reception signal, the double-talk detector 13 and the echo suppressor 18 are operated. Additionally, the double-talk detector 13 and the echo suppressor 18 may perform various types of data collection operation regardless of whether the voice signal is included in the reception signal or not. The delay unit 19 delays the reception signal, and supplies the delayed reception signal to the echo suppressor 18.

An example of the echo suppressor will be described. The echo suppressor 18 suppresses echo by multiplying an input signal from which the cancellation signal has been subtracted by the subtraction unit 12 by an attenuation coefficient. When the double-talk state or a single-talk state on the talker side is not detected by the double-talk detector 13, the echo suppressor 18 multiplies a signal on the signal path 5 of the talker-side by the attenuation coefficient and adds the amount of attenuation to the signal, and suppresses echo. When the double-talk state or the single-talk state on the talker side is detected by the double-talk detector 13, the echo suppressor 18 preferably does not add the amount of attenuation to the signal on the signal path 5 of the talker-side.

The echo suppressor 18 converts the reception signal obtained through the delay unit 19 to frequency domain signal and converts a transmission signal to frequency domain signal. Then the echo suppressor 18 observes a temporal change of the converted signal in respective frequency range, and determines the amount of attenuation, that is, the amount of echo suppression, based on comparison or correlation of the temporal changes. The echo suppressor 18 effectively attenuates the echo by the determined amount of echo suppression. Example operation of the echo suppressor 18 will be described below.

Additionally, in the present example, the detection result of the double-talk detector 13 is input to the echo suppressor 18. The echo suppressor 18 may further control the amount of echo suppression by using the information of the detection result from the double-talk detector 13. For example, the double-talk detector 13 may represent the detection result by a gradual index of detection probability or the like. The echo suppressor 18 may calculate the amount of echo suppression according to the level of the index, or may determine the amount of echo suppression by using a table based on the index. Furthermore, the echo suppressor 18 may assume the double-talk state with correlation between the reception signal delayed by the delay unit 19 and the transmission signal input from the microphone 3, and control the amount of echo suppression.

Next, an overview of operation of the echo removal device 100 will be described. In the echo removal device 100, a reception signal which is an analog signal is converted by the A/D converter 21 to a digital signal. The digital signal converted by the A/D converter 21 is input to the delay unit 19, and the delay unit 15 in the echo canceller 1. Moreover, the digital signal converted by the A/D converter 21 is input to the D/A converter 22, and is converted to an analog signal. The analog signal converted by the D/A converter 22 is output from the speaker 2.

In the echo removal device 100, an input signal for the microphone 3 is an analog signal including acoustic echo due to the output of the speaker 2, and the voice of the talker. The input signal for the microphone 3 is converted by the A/D converter 23 to a digital signal. The digital signal converted by the A/D converter 23 is input to the echo canceller 1. The echo canceller 1 generates a cancellation signal for removing the acoustic echo, and subtracts the cancellation signal from the digital signal converted by the A/D converter 23. The digital signal from which the cancellation signal has been subtracted is input to the echo suppressor 18.

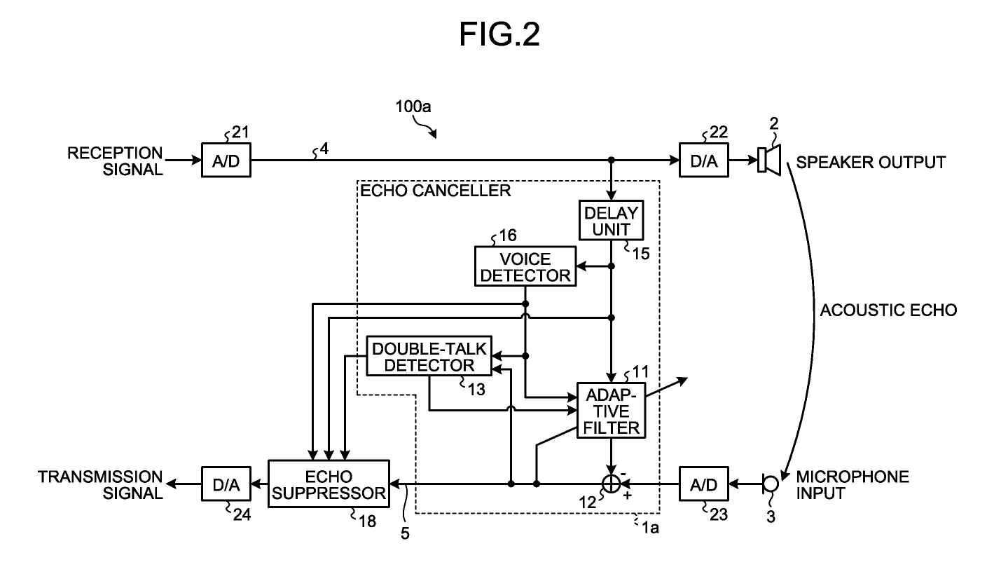

An example of a general echo removal device will be described. FIG. 2 is a diagram illustrating an example configuration of a general echo removal device. An echo removal device 100a illustrated in FIG. 2 includes the echo canceller 1a, and the echo suppressor 18. The echo canceller 1a includes the adaptive filter 11, the subtraction unit 12, the double-talk detector 13, the delay unit 15, and the voice detector 16.

As illustrated in FIG. 2, the same amount of delay is added to the adaptive filter 11 and the echo suppressor 18 by one delay unit 15. Accordingly, there is a possibility that the echo suppressor 18 does not function accurately. For example, since there is a temporal shift between the reception signal and the transmission signal input to the echo suppressor 18, the double-talk state may not be correctly determined, and the amount of attenuation may not be appropriately added to the signal on the signal path 5 of the talker-side.

According to the configuration illustrated in FIG. 2, a reception signal delayed by the delay unit 15 is input to the adaptive filter 11, and also, the same delayed signal is input to the echo suppressor 18. Accordingly, the same reception signal delayed by the delay unit 15 is input to the adaptive filter 11 and the echo suppressor 18. According to this configuration, the timing of operation of the echo suppressor 18 may sometimes be shifted. Therefore, the double-talk detector 13 may not detect the double-talk state and the echo suppressor 18 may be operated on the double-talk state, or the double-talk state may be detected and the echo suppressor 18 may not be operated after the end of the double-talk state.

On the other hand, the echo removal device 100 according to the present embodiment described with reference to FIG. 1 includes the delay unit 19, in addition to the delay unit 15 in the echo canceller 1. A reception signal to which a different amount of delay from the amount of delay added by the delay unit 15 in the echo canceller 1 is added may be input to the echo suppressor 18 by the delay unit 19.

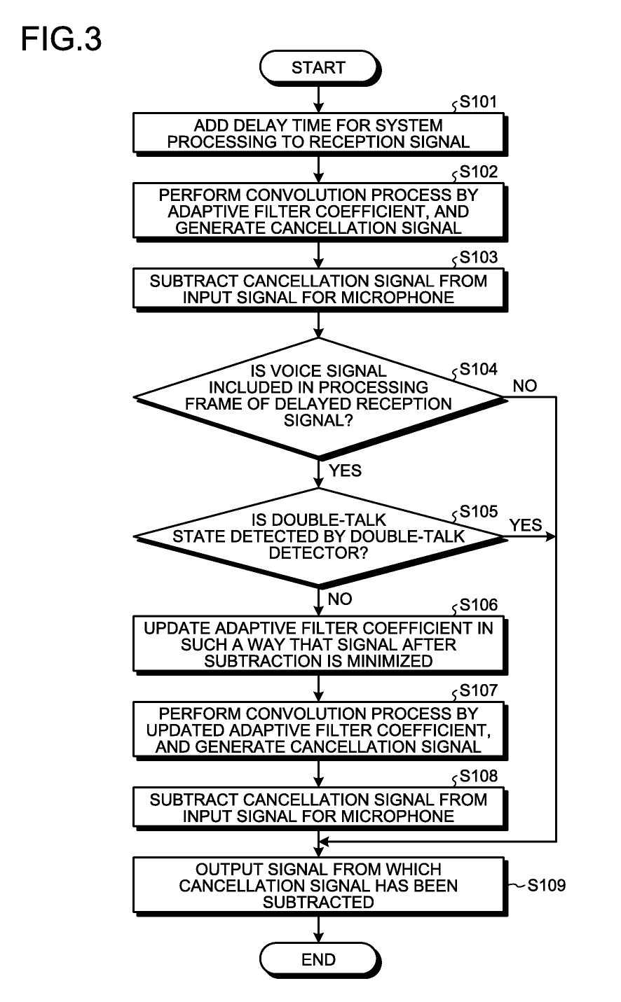

An example of echo cancellation processing will be described. FIG. 3 is a flowchart illustrating an example of echo cancellation operation of the echo canceller 1. In step S101, the delay unit 15 adds delay time for system processing in the present device to a reception signal. In step S102, the adaptive filter 11 performs a convolution process by an adaptive filter coefficient, and generates a cancellation signal. In step S103, the subtraction unit 12 subtracts the cancellation signal from an input signal for the microphone 3.

In step S104, the voice detector 16 determines whether a voice signal is included in a processing frame of the reception signal delayed by the delay unit 15. In step S104, if the voice signal is included in the processing frame of the reception signal delayed by the delay unit 15 (Yes in step S104), the process proceeds to step S105.

In step S105, whether a double-talk state is detected by the double-talk detector 13 is determined. In step S105, if the double-talk state is not detected by the double-talk detector 13 (No in step S105), the process proceeds to step S106.

In step S106, the adaptive filter 11 updates the adaptive filter coefficient in such a way that the signal after the subtraction is minimized. In step S107, the adaptive filter 11 performs the convolution process by the updated adaptive filter coefficient, and generates the cancellation signal. In step S108, the subtraction unit 12 subtracts the cancellation signal from the input signal for the microphone 3. In step S109, the signal from which the cancellation signal has been subtracted is output.

Additionally, in step S104, if the voice signal is not included in the processing frame of the reception signal delayed by the delay unit 15 (No in step S104), the process proceeds to step S109, and the signal from which the cancellation signal has been subtracted is output.

Furthermore, in step S105, if the double-talk state is detected by the double-talk detector 13 (Yes in step S105), the process proceeds to step S109, and the signal from which the cancellation signal has been subtracted is output.

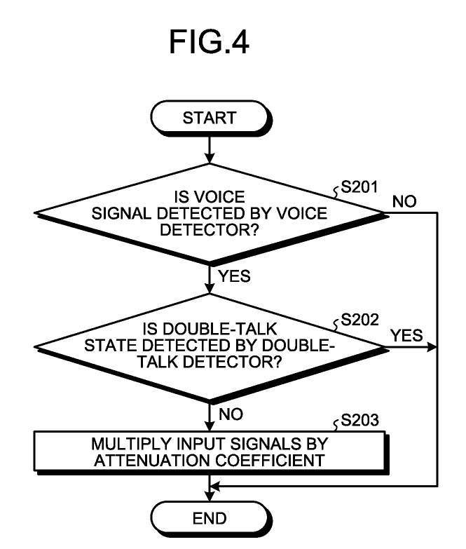

An example processing by the echo suppressor will be described. FIG. 4 is a flowchart illustrating an example of operation of the echo suppressor 18 in FIG. 1. In step S201, the echo suppressor 18 determines whether a voice signal is detected by the voice detector 17. In step S201, if the voice signal is detected by the voice detector 17 (Yes in step S201), the process proceeds to step S202.

In step S202, the echo suppressor 18 determines whether a double-talk state is detected by the double-talk detector 13. In step S202, if the double-talk state is not detected by the double-talk detector 13 (No in step S202), the process proceeds to step S203. In step S203, the echo suppressor 18 multiplies input signals by an attenuation coefficient.

Additionally, if the voice signal is not detected by the voice detector 17 in step S201 (No in step S201), or the double-talk state is detected by the double-talk detector 13 in step S202 (Yes in step S202), the process directly ends.

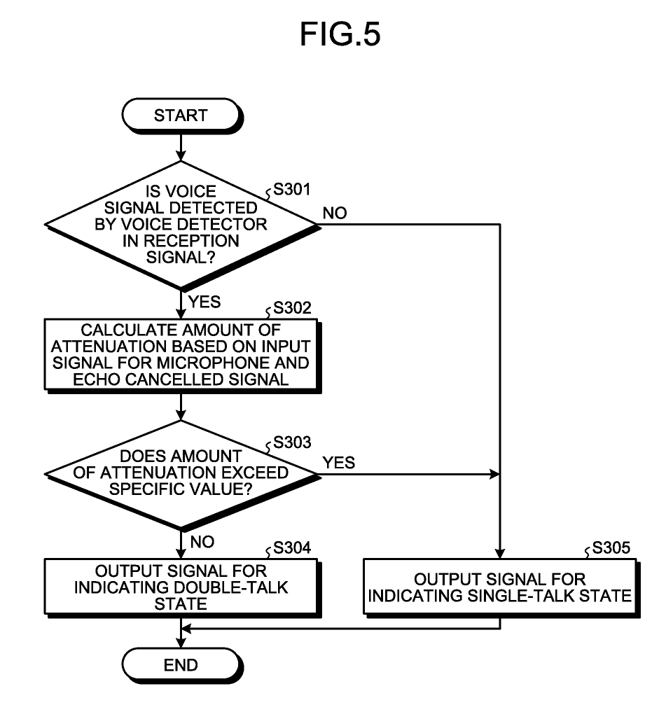

An example processing by the double-talk detector will be described. FIG. 5 is a flowchart illustrating an example of operation of the double-talk detector 13 in FIG. 1. In step S301, whether a voice signal is detected by the voice detector 17 in a reception signal delayed by the delay unit 19 is determined. In step S301, if the voice signal is detected by the voice detector 17 (Yes in step S301), the process proceeds to step S302.

In step S302, the double-talk detector 13 calculates amount of attenuation based on an input signal for the microphone 3 and the echo cancelled signal. In step S303, the double-talk detector 13 determines whether the amount of attenuation exceeds a specific value.

In step S303, if the amount of attenuation does not exceed the specific value (No in step S303), the process proceeds to step S304, and the double-talk state is determined and a signal for indicating the double-talk state is output. Then, the process ends.

On the other hand, if the amount of attenuation exceeds the specific value in step S303 (Yes in step S303), the process proceeds to step S305, and a single-talk state is determined and a signal for indicating the single talk state is output. Then, the process ends.

Additionally, in step S301, if a voice signal is not detected by the voice detector 17 (No in step S301), the process also proceeds to step S305, and the single-talk state is determined and the signal for indicating the single talk is output. Then, the process ends.

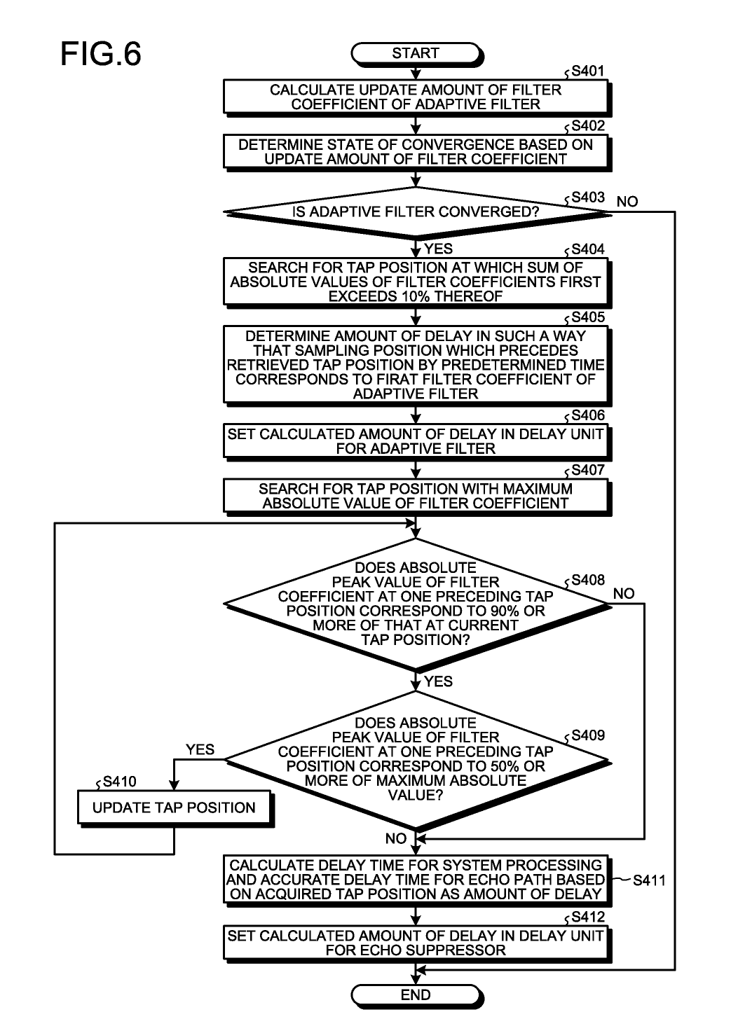

An example processing by the delay amount calculator will be described. FIG. 6 is a flowchart illustrating an example of operation of the delay amount calculator 14 in FIG. 1. In step S401, the delay amount calculator 14 calculates the update amount of the filter coefficient of the adaptive filter. In step S402, the delay amount calculator 14 determines the state of convergence of the adaptive filter 11 based on the update amount of the filter coefficient.

In step S403, the delay amount calculator 14 determines whether the adaptive filter 11 is converged. In step S403, if the adaptive filter 11 is determined to be converged (Yes in step S403), the process proceeds to step S404.

In step S404, the delay amount calculator 14 searches for a tap position at which a sum of absolute values of the filter coefficients first exceeds 10% thereof. In step S405, the delay amount calculator 14 determines an amount of delay in such a way that a sampling position which precedes the retrieved tap position by a predetermined time corresponds to a first filter coefficient of the adaptive filter 11. In step S406, the delay amount calculator 14 sets the calculated amount of delay in the delay unit 15 for the adaptive filter 11.

In step S407, the delay amount calculator 14 searches for a tap position with a maximum absolute value of the filter coefficient of the adaptive filter 11.

In step S408, the delay amount calculator 14 determines whether an absolute peak value of the filter coefficient at the one preceding tap position corresponds to 90% or more of that at the current tap position. In step S408, if the absolute peak value of the filter coefficient at the one preceding tap position is determined to correspond to 90% or more of that at the current tap position (Yes in step S408), the process proceeds to step S409.

In step S409, the delay amount calculator 14 determines whether the absolute peak value of the filter coefficient at the one preceding tap position corresponds to 50% or more of the maximum absolute value of the filter coefficient. In step S409, if the absolute peak value of the filter coefficient at the one preceding tap position corresponds to 50% or more of the maximum absolute value of the filter coefficient (Yes in step S409), the process proceeds to step S410. In step S410, the delay amount calculator 14 updates the tap position, and returns to the process in step S408.

If the delay amount calculator 14 determines, in step S408, that the absolute peak value of the filter coefficient at the one preceding tap position does not correspond to 90% or more of that at the current tap position (No in step S408), or determines, in step S409, that the absolute peak value of the filter coefficient at the one preceding tap position does not correspond to 50% or more of the maximum absolute value of the filter coefficient (No in step S409), the process proceeds to step S411.

In step S411, the delay amount calculator 14 calculates the delay time for the system processing and accurate delay time for the echo path as an amount of delay to be set in the delay unit 19 based on the acquired tap position. In step S412, the delay amount calculator 14 sets the amount of delay in the delay unit 19 for the echo suppressor 18.

Additionally, in a case where the adaptive filter 11 is determined to be not converged (No in step S403) in step S403, the processing by the delay amount calculator 14 ends.

According to the processing from steps S407 to S412 described above, the delay amount calculator 14 searches for a tap position with the maximum absolute value of the filter coefficient when the adaptive filter 11 is converged, and updates the tap position as long as a predetermined condition is satisfied, and when the predetermined condition is no longer satisfied, the delay amount calculator 14 calculates the amount of delay to be set in the delay unit 19 based on the tap position. According to such processing, an appropriate amount of delay may be set in the delay unit 19 for the echo suppressor 18. Additionally, the numerical values of “90% or more of the absolute peak value at the current tap position” in the determination in step S408 and “50% or more of the maximum absolute value” in the determination in step S409 are merely examples, and conditions for updating the tap position may be arbitrarily set.

The echo removal device according to the present embodiment may be applied to hands-free calling in a vehicle, videophone, or hands-free calling using a smartphone, for example.

An echo removal method below is realized by the echo removal device described above. That is, an echo removal method is realized, which includes; delaying a reception signal from a communication counterpart by a first delay unit; generating a cancellation signal that is generated based on the delayed reception signal obtained by the first delay unit and property information which simulates a property of an echo path; subtracting the cancellation signal from a transmission signal for the communication counterpart; delaying the reception signal by a second delay unit by an amount of delay different from an amount of delay of the first delay unit; calculating and setting the amount of delay of the first delay unit and the amount of delay of the second delay unit based on the property information; and attenuating the transmission signal based on the delayed reception signal obtained by the second delay unit and the transmission signal subtracted by the cancellation signal. According to the echo removal method, echo can be more reliably removed.

The echo removal device described above may be realized by using a non-transitory storage medium that stores an echo removal program. Echo can be removed more reliably by using the non-transitory storage medium that stores the echo removal program for causing a computer to function as: an echo canceller that includes a first delay unit configured to delay a reception signal from a communication counterpart, and that is configured to subtract, from a transmission signal for the communication counterpart, a cancellation signal that is generated based on the delayed reception signal obtained by the first delay unit and property information which simulates a property of an echo path; a second delay unit configured to delay the reception signal by an amount of delay different from an amount of delay of the first delay unit; an echo suppressor configured to receive the delayed reception signal obtained by the second delay unit and an output of the echo canceller; and a delay amount calculator configured to calculate and set the amount of delay of the first delay unit and the amount of delay of the second delay unit based on the property information. According to the e non-transitory storage medium that stores the echo removal program, echo can be removed more reliably.

Although the application has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An echo removal device comprising:
an echo canceller
that includes a first delay unit configured to delay a reception signal from a communication counterpart, and
that is configured to subtract, from a transmission signal for the communication counterpart, a cancellation signal that is generated based on the delayed reception signal obtained by the first delay unit and property information which simulates a property of an echo path;
a second delay unit configured to delay the reception signal by an amount of delay different from an amount of delay of the first delay unit;
an echo suppressor configured to receive the delayed reception signal obtained by the second delay unit and an output of the echo canceller; and
a delay amount calculator configured to calculate and set the amount of delay of the first delay unit and the amount of delay of the second delay unit based on the property information.

2. The echo removal device according to claim 1, wherein
the echo suppressor is further configured to attenuate the transmission signal from which the cancellation signal has been subtracted.

3. The echo removal device according to claim 1, further comprising:
a voice detector configured to detect a voice signal from the communication counterpart; and
a double-talk detector configured to detect a double-talk state in which a talker and a listener speak at a same time,
wherein the echo suppressor is further configured to attenuate the transmission signal for the communication counterpart when the voice signal is detected by the voice detector and the double-talk state is not detected by the double-talk detector, and does not attenuate the transmission signal for the communication counterpart when the voice signal is not detected by the voice detector or the double-talk state is detected by the double-talk detector.

4. The echo removal device according to claim 1, wherein
the echo canceller includes an adaptive filter configured to generate the cancellation signal based on the property information, and a subtraction unit configured to subtract the cancellation signal from the transmission signal.

5. The echo removal device according to claim 4, wherein
the delay amount calculator is further configured to search for a tap position with a maximum absolute value of filter coefficient of the adaptive filter when the adaptive filter is converged, and
to update the tap position when a predetermined condition is satisfied, and
to calculate the amount of delay to be set in the second delay unit based on the tap position when the predetermined condition is no longer satisfied.

6. An echo removal method comprising:
delaying a reception signal from a communication counterpart by a first delay unit;
generating a cancellation signal that is generated based on the delayed reception signal obtained by the first delay unit and property information which simulates a property of an echo path;
subtracting the cancellation signal from a transmission signal for the communication counterpart;
delaying the reception signal by a second delay unit by an amount of delay different from an amount of delay of the first delay unit;
calculating and setting the amount of delay of the first delay unit and the amount of delay of the second delay unit based on the property information; and
attenuating the transmission signal based on the delayed reception signal obtained by the second delay unit and the transmission signal subtracted by the cancellation signal.

7. A non-transitory storage medium that stores an echo removal program for causing a computer to function as:
an echo canceller that includes a first delay unit configured to delay a reception signal from a communication counterpart, and that is configured to subtract, from a transmission signal for the communication counterpart, a cancellation signal that is generated based on the delayed reception signal obtained by the first delay unit and property information which simulates a property of an echo path;
a second delay unit configured to delay the reception signal by an amount of delay different from an amount of delay of the first delay unit;
an echo suppressor configured to receive the delayed reception signal obtained by the second delay unit and an output of the echo canceller; and
a delay amount calculator configured to calculate and set the amount of delay of the first delay unit and the amount of delay of the second delay unit based on the property information.
